(19) United States
(12) Patent Application Publication
(10) Pub. No.: US 2015/0212029 A1
(43) Pub. Date: Jul. 30, 2015

(54) TUNABLE CHEMICAL SENSING DEVICE

(71) Applicant: SENSOR TEK Co., Ltd., Taipei City (TW)

(72) Inventors: Mao-Chen LIU, Jiji Township (TW); Hao-Ming CHAO, Taipei City (TW); Wen-Chieh CHOU, Guishan Township (TW); Po-Wei LU, Bade City (TW); Shu-Yi WENG, Zhunan Township (TW); Chun-Chieh WANG, Taichung City (TW)

(21) Appl. No.: 14/608,948

(22) Filed: Jan. 29, 2015

(30) Foreign Application Priority Data
Jan. 29, 2014 (TW) 103103506

(51) Int. Cl. G01N 27/02

(52) U.S. Cl. CPC G01N 27/028

(57) ABSTRACT

A tunable chemical sensing device includes a sensing unit, a plurality of first pads, a value reading circuit and a plurality of second pads. The sensing unit has a first impedance component and a plurality of second impedance components. The first impedance component and the second impedance components respectively have a first terminal and a second terminal. The second impedance components respectively have a different impedance value. The first pads are respectively coupled to the corresponding first and second terminals. The value reading circuit has a first input terminal, a second input terminal and an output terminal. The second pads are respectively coupled to the corresponding first input terminal, second input terminal and output terminal. A coupling relationship between the first pads and the second pads is adjusted to tune an impedance value of the sensing unit.

### CROSS-REFERENCE TO RELATED APPLICATIONS

This non-provisional application claims priority under 35 U.S.C. §119(a) on Patent Application No. 103103506 filed in Taiwan, R.O.C on Jan. 29, 2014, the entire contents of which are hereby incorporated by reference.

### BACKGROUND OF THE INVENTION

1. Technical Field of the Invention

The present invention relates to a chemical sensing device, particularly to a tunable chemical sensing device.

2. Description of the Related Art

Generally, a chemical sensor changes its physical quantity of a resistor or capacitor according to the concentration of the gas or liquid for testing and reflects the state of the gas or liquid according to the variation of the physical quantity of the resistor or capacitor. The chemical sensor is often used as a carbon monoxide sensor, an oxygen sensor, or a humidity sensor, so the accuracy, stability, and energy saving characteristic of the chemical sensor are very important.

Moreover, the manufacture of the chemical sensor needs extra sensing materials, such as metallic oxide, for example, SnO2 and WO2, and high molecular material, for example, Polyimide. However, in the manufacture process of the chemical sensor, when the metal deposition or the coated high molecular material is uneven on the whole wafer, the initial value of the chemical sensor varies and errors occur in the physical quantity of the resistor or capacitor outputted from the chemical sensor accordingly. Therefore, controlling the initial value of the chemical sensor still has much room for improvement.

### SUMMARY OF THE INVENTION

A tunable chemical sensing device illustrated in an embodiment of the present invention includes a sensing unit, a plurality of first pads, a value reading circuit, and a plurality of second pads. The sensing unit has a first impedance component and at least two second impedance components, wherein each of the first impedance component and the second impedance components has a first terminal and a second terminal, and the impedance values of the second impedance components are different from each other. The sensing unit has a first impedance component and a plurality of second impedance components, wherein the first impedance component has a first terminal and a second terminal and each of the plurality of second impedance components has a first terminal and a second terminal, and the impedance values of the plurality of second impedance components are different. Each of the plurality of first pads is coupled with the corresponding one among the plurality of first terminals and the plurality of second terminals. The value reading circuit has a first input terminal, a second input terminal, and an output terminal. The plurality of second pads are correspondingly coupled with the first input terminal, the second input terminal, and the output terminal respectively. The impedance value of the sensing unit is tuned by adjusting a coupling relationship between the plurality of first pads and the plurality of second pads and a sensing value corresponding to the impedance value of the sensing unit is outputted from the second pad coupled with the output terminal.

In an embodiment, the first impedance component a resistor and the plurality of second impedance components are capacitors.

In an embodiment, the first impedance component and the plurality of second impedance components are resistors.

In an embodiment, the value reading circuit is an operational amplifier.

In an embodiment, the tunable chemical sensing device further includes a printed circuit board having a plurality of third pads and a plurality of connection wires, wherein the plurality of third pads are separately coupled with the corresponding plurality of first pads and the corresponding plurality of second pads, and the plurality of connection wires are coupled with the corresponding plurality of third pads to adjust the coupling relationship.

In an embodiment, the plurality of third pads are coupled with the corresponding plurality of first pads and the corresponding plurality of second pads respectively through wire bonding.

### BRIEF DESCRIPTION OF THE DRAWINGS

The present invention will become more fully understood from the detailed description given hereinbelow and the accompanying drawings, which are given by way of illustration only and thus are not limitative of the present invention and wherein:

FIG. 1 is a diagram of the tunable chemical sensing device according to an embodiment of the present invention;

FIG. 2A is the first embodiment of the equivalent circuit of the tunable chemical sensing device in FIG. 1;

FIG. 2B is the second embodiment of the equivalent circuit of the tunable chemical sensing device in FIG. 1;

FIG. 3 is a diagram of the tunable chemical sensing device according to another embodiment of the present invention;

FIG. 4A is the first embodiment of the equivalent circuit of the tunable chemical sensing device in FIG. 3; and

FIG. 4B is the second embodiment of the equivalent circuit of the tunable chemical sensing device in FIG. 3.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

In the following embodiments, the same symbols represent the same or similar components.

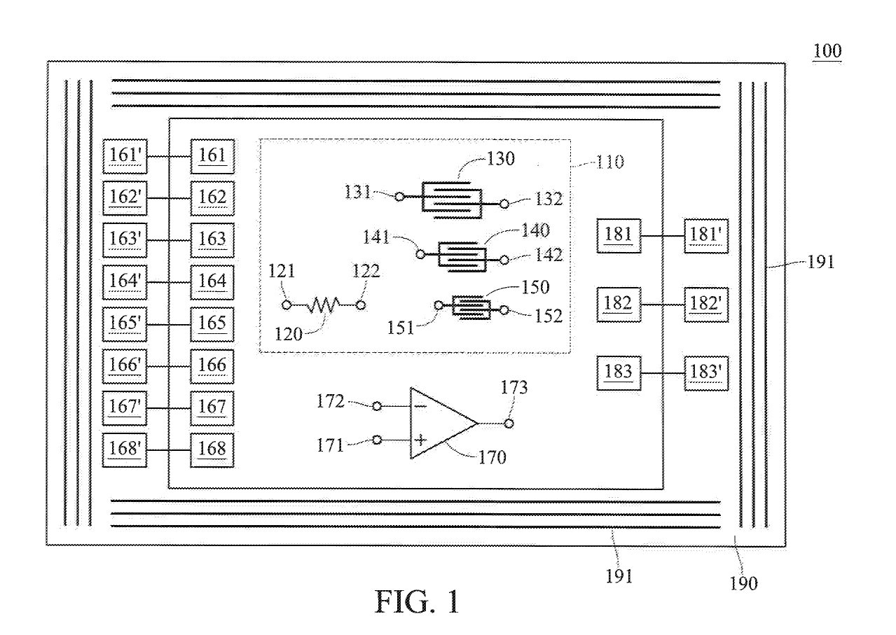

Please refer to FIG. 1. FIG. 1 is a diagram of the tunable chemical sensing device according to an embodiment of the present invention. As shown in FIG. 1, the tunable chemical sensing device 100 includes a sensing unit 110, a plurality of first pads 161, 162, 163, 164, 165, 166, 167, 168, a value reading circuit 170, and a plurality of second pads 181, 182, 183. The sensing unit 110, the plurality of first pads 161, 162, 163, 164, 165, 166, 167, 168, the value reading circuit 170, and the plurality of second pads 181, 182, 183 are implemented with system on chip (SOC).

The sensing unit 110 has a first impedance component 120 and a plurality of second impedance component 130, 140, 150. The first impedance component 120 has a first terminal 121 and a second terminal 122, and the second impedance component 130 has a first terminal 131 and a second terminal 132, and the second impedance component 140 has a first terminal 141 and a second terminal 142, and the second impedance component 150 has a first terminal 151 and a second terminal 152. The impedance values of the second impedance component 130, 140, 150 are different and for example, the relationship among the impedance values is: the second impedance component 130>the second impedance component 140>the second impedance component 150. In the present embodiment, the first impedance component 120 is a resistor and the second impedance components 130, 140, 150 are capacitors. The present embodiment is for illustrating but not for limiting the present invention.

Each of the plurality of first pads 161, 162, 163, 164, 165, 166, 167, 168 is coupled with the corresponding one among the plurality of first terminals 121, 131, 141, 151 and the plurality of second terminals 122, 132, 142, 152. For example, the first pad 161 is coupled with the first terminal 121, and the first pad 162 is coupled with the second terminal 122, and the first pad 163 is coupled with the first terminal 131, and the first pad 164 is coupled with the second terminal 132, and the first pad 165 is coupled with the first terminal 141, and the first pad 166 is coupled with the second terminal 142, and the first pad 167 is coupled with the first terminal 151, and the first pad 168 is coupled with the second terminal 152.

The value reading circuit 170 has a first input terminal 171, a second input terminal 172 and an output terminal 173. In the present embodiment, the value reading circuit 170 is an operational amplifier, and the first input terminal 171 of the value reading circuit 170 is a positive input terminal of the operational amplifier, and the second input terminal 172 of the value reading circuit 170 is a negative input terminal of the operational amplifier, and the output terminal 173 of the value reading circuit 170 is an output terminal of the operational amplifier. The present embodiment is for illustrating but not for limiting the present invention.

The plurality of second pads 181, 182, 183 are correspondingly coupled with the first input terminal 171, the second input terminal 172, and the output terminal 173 respectively. For example, the second pad 181 is coupled with the first input terminal 171, and the second pad 182 is coupled with the second input terminal 172, and the second pad 183 is coupled with the output terminal 173.

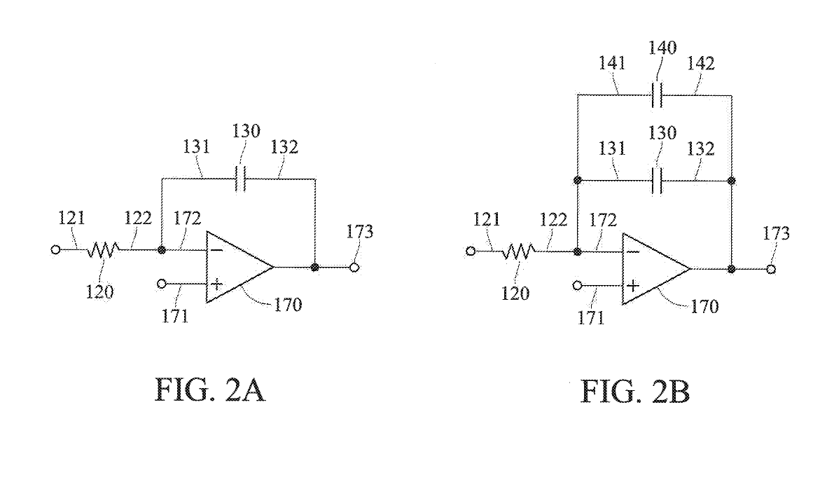

The impedance value of the sensing unit 110 is tuned by adjusting a coupling relationship between the first pads 161, 162, 163, 164, 165, 166, 167, 168 and the second pads 181, 182, 183. In an embodiment, assuming that the first pad 162, the first pad 163, and the second pad 182 are coupled, and the first pad 164 are coupled with the second pad 183, the equivalent circuit formed by the tunable chemical sensing device 100 is shown in FIG. 2A, wherein the first pad 162 is the second terminal 122 of the first impedance component 120, and the first pad 163 is the first terminal 131 of the second impedance component 130, and the second pad 182 is the second input terminal 172 of the value reading unit 170. Next, the sensing value corresponding to the impedance value of the sensing unit 110 is outputted from the second pad 182 coupled with the output terminal 173 of the value reading unit 170.

In another embodiment, assuming that the first pad 162, the first pad 163, the first pad 165, the second pad 182 are coupled, and the first pad 164, the first pad 166, and the second pad 183 are coupled, and the second impedance component 130 and 140 are coupled in parallel connection, consequently the equivalent circuit shown in FIG. 2B is formed by the tunable chemical sensing device 100. For example, the first pad 162 is the second terminal 122 of the first impedance component 120, and the first pad 163 is the first terminal 131 of the second impedance component 130, and the first pad 165 is the first terminal 141 of the second impedance component 140, and the second pad 182 is the second input terminal 172 of the value reading unit 170, and the first pad 164 is the second terminal 132 of the second impedance component 130, and the first pad 166 is the second terminal 142 of the second impedance component 140, and the second pad 183 is the output terminal 173 of the value reading unit 170. Next, the sensing value corresponding to the impedance value of the sensing unit 110 is outputted from the second pad 182 coupled with the output terminal 173 of the value reading unit 170, wherein the impedance value of the sensing unit 110 is, for example, the impedance value of the second impedance component 130 and 140 in parallel connection.

In the previous embodiment, taking the second impedance component 130 and 140 in parallel connection for example, the second impedance component 130 and 140 can also be in series connection. Therefore, by adjusting the coupling relationship between the first pads 161, 162, 163, 164, 165, 166, 167, 168 and the second pads 181, 182, 183, the impedance value of the sensing unit 110 is tuned, so that each sensing unit 110 has the same initial impedance value, such as the initial value of the capacitor. Therefore, the initial error of the impedance between each tunable chemical sensing device 100 is further decreased. In addition, the number of the second impedance components is but not limited to 3, and the user is available to adjust the number of the second impedance components to 2 or more than 3.

In addition, the tunable chemical sensing device 100 further includes a printed circuit board 190. The printed circuit board 190 has a plurality of third pads 161′, 162′, 163′, 164′, 165′, 166′, 167′, 168′, 181′, 182′, 183′, and a plurality of connection wires 191. The third pads 161′, 162′, 163′, 164′, 165′, 166′, 167′, 168′, 181′, 182′, 183′ are coupled with the corresponding first pads 161, 162, 163, 164, 165, 166′, 167, 168 and second pads 181, 182, 183 respectively. In the present embodiment, the third pads 161′, 162′, 163′, 164′, 165′, 166′, 167′, 168′, 181′, 182′, 183′ are coupled with the corresponding first pads 161, 162, 163, 164, 165, 166′, 167, 168 and second pads 181, 182, 183 through wire bonding respectively. The present embodiment is for illustrating but not for limiting the present invention.

For example, the third pad 161′ is coupled with the first pad 161, and the third pad 162′ is coupled with the first pad, and the third pad 163′ is coupled with the first pad 163, and the third pad 164′ is coupled with the first pad 164, and the third pad 165′ is coupled with the first pad 165, and the third pad 166′ is coupled with the first pad 166, and the third pad 167′ is coupled with the first pad 167, and the third pad 168′ is coupled with the first pad 168, and the third pad 181′ is coupled with the second pad 181, and the third pad 182′ is coupled with the second pad 182, and the third pad 183′ is coupled with the second pad 183.

By coupling the connection wire 191 on the printed circuit board 190 with the corresponding third pad, the coupling relationship between the first pad and the second pad is adjusted, and the impedance value of the sensing unit 110 is further tuned.

In the previous embodiment, the first impedance component 120 is but not limited to a resistor, and the second impedance components 130, 140, 150 are but not limited to capacitors. In addition, another embodiment is explained as follows.

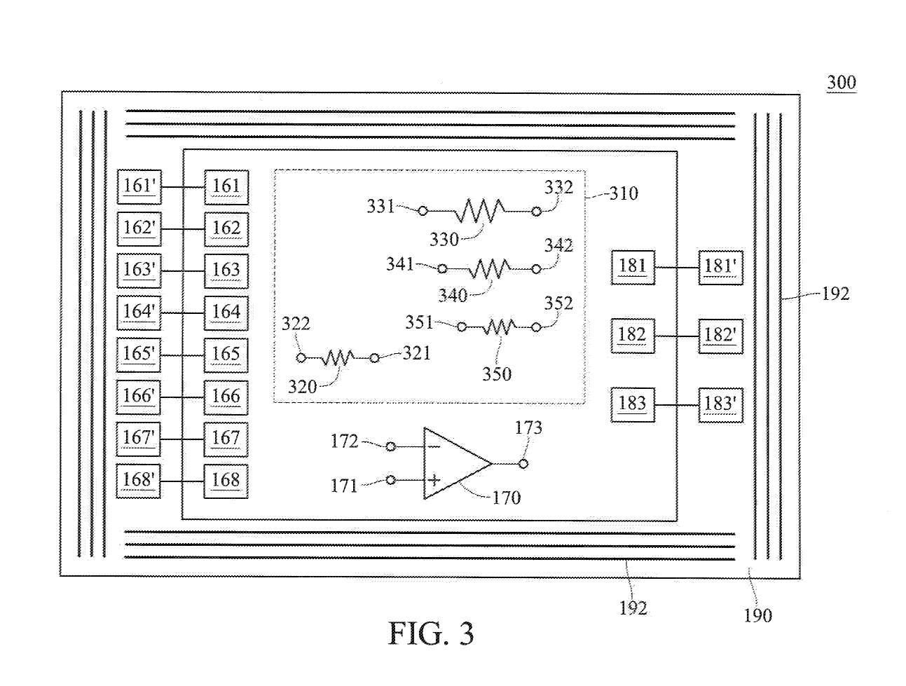

Please refer to FIG. 3. FIG. 3 is a diagram of the tunable chemical sensing device according to another embodiment of the present invention. The tunable chemical sensing device 300 includes a sensing unit 310, a plurality of first pads 161, 162, 163, 164, 165, 166, 167, 168, a value reading circuit 170, and a plurality of second pads 181, 182, 183.

The sensing unit 310 has a first impedance component 320 and a plurality of second impedance components 330, 340, 350. The first impedance component 320 has a first terminal 321 and a second terminal 322, and the second impedance component 330 has a first terminal 331 and a second terminal 332, and the second impedance component 340 has a first terminal 341 and a second terminal 342, and the second impedance component 350 has a first terminal 351 and a second terminal 352. The impedance values of the second impedance components 330, 340, 350 are different, and for example, the relationship among the impedance values is: the second impedance component 330>the second impedance component 340>the second impedance component 350. In the present embodiment, the first impedance component 320 and the second impedance components 330, 340, 350 are resistors. The present embodiment is for illustrating but not for limiting the present invention.

Each of the first pads 161, 162, 163, 164, 165, 166, 167, 168 is coupled with the corresponding one among the plurality of first terminals 321, 331, 341, 351 and the plurality of second terminals 322, 332, 342, 352. For example, the first pad 161 is coupled with the first terminal 331, and the first pad 162 is coupled with the second terminal 322, and the first pad 163 is coupled with the first terminal 331, and the first pad 164 is coupled with the second terminal 332, and the first pad 165 is coupled with the first terminal 341, and the first pad 166 is coupled with the second terminal 342, and the first pad 167 is coupled with the first terminal 351, and the first pad 168 is coupled with the second terminal 352.

The value reading circuit 170 has a first input terminal 171, a second input terminal 172, and an output terminal 173. In the present embodiment, the value reading circuit 170 is an operational amplifier, and the first input terminal 171 of the value reading circuit 170 is the positive input terminal of the operational amplifier, and the second input terminal 172 of the value reading circuit 170 is the negative input terminal of the operational amplifier, and the output terminal 173 of the value reading circuit 170 is the output terminal of the operational amplifier. The present embodiment is for illustrating but not for limiting the present invention.

The plurality of second pads 181, 182, 183 are correspondingly coupled with the first input terminal 171, the second input terminal 172, and the output terminal 173 respectively. For example, the second pad 181 is coupled with the first input terminal 171, and the second pad 182 is coupled with the second input terminal 172, and the second pad 183 is coupled with the output terminal 173.

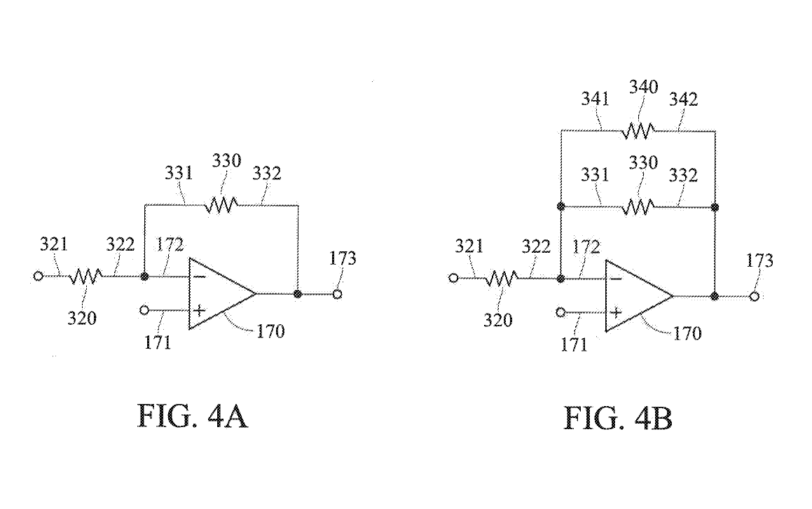

In addition, by adjusting the coupling relationship between the first pads 161, 162, 163, 164, 165, 166, 167, 168 and the second pads 181, 182, 183, the impedance value of the sensing unit 110 is tuned. In an embodiment, assuming that the first pad 162, the first pad 163, and the second pad 182 are coupled, and the first pad 164 and the second pad 183 are coupled, then the equivalent circuit shown in FIG. 4A is formed by the tunable chemical sensing device 300. For example, the first pad 162 is the second terminal 322 of the first impedance component 320, and the first pad 163 is the first terminal 331 of the second impedance component 330, and the second pad 182 is the second input terminal 172 of the value reading unit 170, and the first pad 164 is the second terminal 332 of the second impedance component 330, and the second pad 183 is the output terminal 173 of the value reading unit 170. Next, the sensing value corresponding to the impedance value of the sensing unit 310 is outputted from the second pad 182 coupled with the output terminal 173 of the value reading unit 170. For example, the impedance value of the sensing unit 310 is the impedance value of the corresponding second impedance component 330.

In another embodiment, assuming that the first pad 162, the first pad 163, the first pad 165, and the second pad 182 are coupled, and the first pad 164, the first pad 166, and the second pad 183 are coupled, and the second impedance component 330 and 340 are coupled in parallel connection, then the equivalent circuit shown in FIG. 4B is formed by the tunable chemical sensing device 300. For example, the first pad 162 is the second terminal 322 of the first impedance component 320, and the first pad 163 is the first terminal 331 of the second impedance component 330, and the first pad 165 is the first terminal 341 of the second impedance component 340, and the second pad 182 is the second input terminal 172 of the value reading unit 170, and the first pad 164 is the second terminal 332 of the second impedance component 330, and the first pad 166 is the second terminal 342 of the second impedance component 340, and the second pad 183 is the output terminal 173 of the value reading unit 170. Next, the sensing value corresponding to the impedance value of the sensing unit 110 is outputted from the second pad 182 coupled with the output terminal 173 of the value reading unit 170. For example, the impedance value of the sensing unit 110 is the impedance value of the second impedance component 330 and 340 in parallel connection.

Therefore, the user adjusts the coupling relationship between the first pads 161, 162, 163, 164, 165, 166, 167, 168 and the second pads 181, 182, 183 according to the need to tune the impedance value of the sensing unit 110, so that each sensing unit 310 has the same initial impedance value, such as the initial value of the capacitor. Therefore, the initial error of the impedance between each tunable chemical sensing device 100 is further decreased.

In addition, the tunable chemical sensing device 300 further includes a printed circuit board 190. The printed circuit board 190 has a plurality of third pads 161′, 162′, 163′, 164′, 165′, 166′, 167′, 168′, 181′, 182′, 183′, and a plurality of connection wires 191. The third pads 161′, 162′, 163′, 164′, 165′, 166′, 167′, 168′, 181′, 182′, 183′ are coupled with the corresponding first pads 161, 162, 163, 164, 165, 166′, 167, 168 and second pads 181, 182, 183 respectively. In the present embodiment, the third pads 161′, 162′, 163′, 164′, 165′, 166′, 167′, 168′, 181′, 182′, 183′ are coupled with the corresponding first pads 161, 162, 163, 164, 165, 166′, 167, 168 and second pads 181, 182, 183 through wire bonding respectively. The present embodiment is for illustrating but not for limiting the present invention.

By coupling the connection wire 191 on the printed circuit board 190 with the corresponding third pad, the coupling relationship between the first pad and the second pad is adjusted, and the impedance value of the sensing unit 110 is further tuned.

The tunable chemical sensing device in an embodiment of the present invention has a sensing unit, a plurality of first pads, a value reading circuit, and a plurality of second pads, and the sensing unit has a first impedance component and a plurality of second impedance components, and the impedance values of the plurality of second impedance components are different. By coupling the first terminal with the corresponding second terminal through the first pad, and coupling the first input terminal, the second input terminal, and the output terminal of the corresponding value reading circuit through the second pad, and further adjusting a coupling relationship between the first pad and the second pad, the impedance value of the sensing unit is adjusted and the sensing value corresponding to the impedance value of the sensing unit is outputted from the second pad coupled with the output terminal. Therefore, the initial impedance value is tuned effectively and the error between each tunable chemical sensing device is decreased.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments of the invention. It is intended, therefore, that the specification and examples be considered as exemplary only, with a true scope and spirit of the invention being indicated by the following claims and their full scope of equivalents.

What is claimed is:

1. A tunable chemical sensing device, comprising:
a sensing unit having a first impedance component and at least two second impedance components, wherein each of the first impedance component and the second impedance components has a first terminal and a second terminal, and the impedance values of the second impedance components are different from each other;
each of the plurality of first pads coupled with the corresponding one among the plurality of first terminals and the plurality of second terminals;
a value reading circuit having a first input terminal, a second input terminal, and an output terminal; and
the plurality of second pads correspondingly coupled with the first input terminal, the second input terminal, and the output terminal respectively;
wherein the impedance value of the sensing unit is tuned by adjusting a coupling relationship between the plurality of first pads and the plurality of second pads and a sensing value corresponding to the impedance value of the sensing unit is outputted from the second pad coupled with the output terminal.

2. The device of claim 1, wherein the first impedance component is a resistor and the plurality of second impedance components are capacitors.

3. The device of claim 1, wherein the first impedance component and the plurality of second impedance components are resistors.

4. The device of claim 1, wherein the value reading circuit is an operational amplifier.

5. The device of claim 1, further comprising a printed circuit board having a plurality of third pads and a plurality of connection wires, wherein the plurality of third pads are separately coupled with the corresponding plurality of first pads and the corresponding plurality of second pads, and the plurality of connection wires are coupled with the corresponding plurality of third pads to adjust the coupling relationship.

6. The device of claim 5, wherein the plurality of third pads are coupled with the corresponding plurality of first pads and the corresponding plurality of second pads respectively through wire bonding.
